(19) United States
(12) Patent Application Publication
(10) Pub. No.: US 2013/0311295 A1
(43) Pub. Date: Nov. 21, 2013

(54) DISPLAY CONTENT ADVERTISING SYSTEM AND METHOD

(71) Applicant: WINSTON PRODUCTS LLC, Cleveland, OH (US)

(72) Inventors: Christopher O'Hara Belby, Breckenridge, CO (US); William Scott Smith, Breckenridge, CO (US)

(73) Assignee: WINSTON PRODUCTS LLC, Cleveland, OH (US)

(21) Appl. No.: 13/895,446

(22) Filed: May 16, 2013

Related U.S. Application Data
(60) Provisional application No. 61/648,208, filed on May 17, 2012.

(51) Int. Cl. G06Q 30/02

(52) U.S. Cl. CPC G06Q 30/0267
USPC 705/14.64

(57) ABSTRACT

A system for providing advertising information to a user includes a holding device attached to a shopping cart. The holding device removably holds a mobile device. The system includes a recognizable indicia supported by the holding device. The recognizable indicia is recognizable by the mobile device. As such, the mobile device can transmit a first set of information related to the recognizable indicia to a server and receive a second set of information from the server in response.

### RELATED APPLICATIONS

This application claims the benefit of U.S. Provisional Application No. 61/648,208, filed on May 17, 2012 the entire disclosure of which is hereby incorporated herein by reference.

### BACKGROUND OF THE INVENTION

1. Field of the Invention

The present invention relates generally to a system for providing advertising information to a user.

2. Discussion of the Prior Art

Mobile devices, including cellular phones, are known and used in many different applications. A shopper can use his/her mobile device, for example, to search for coupons or advertisements at a particular store. Indeed, it is not uncommon for shoppers to push/manipulate a shopping cart while simultaneously holding a mobile device to search for coupons or advertisements. This concurrent holding and manipulation of both the shopping cart and the mobile device can cause a number of problems, including dropped/broken mobile devices, inattentive shoppers, or the like. Accordingly, there is a need and it would be beneficial for a system to provide advertising information to a user using his/her mobile device.

### BRIEF DESCRIPTION OF THE INVENTION

The following presents a simplified summary of the invention in order to provide a basic understanding of some example aspects of the invention. This summary is not an extensive overview of the invention. Moreover, this summary is not intended to identify critical elements of the invention nor delineate the scope of the invention. The sole purpose of the summary is to present some concepts of the invention in simplified form as a prelude to the more detailed description that is presented later.

In accordance with one aspect, the present invention provides a system for providing advertising information to a user. The system includes a holding device attached to a shopping cart. The holding device can removably hold a mobile device. The system includes a recognizable indicia supported by the holding device. The recognizable indicia is recognizable by the mobile device such that the mobile device can transmit a first set of information related to the recognizable indicia to a server and receive a second set of information from the server in response.

In accordance with another aspect, the present invention provides a system for providing advertising information to a user. The system includes a holding device attached to a shopping cart. The holding device can removably hold a mobile device. The system includes a recognizable indicia supported by the holding device. The recognizable indicia is recognizable by the mobile device such that the mobile device can transmit a first set of information related to the recognizable indicia to a server and receive a second set of information from the server in response. The second set of information received by the mobile device includes an advertisement related to a store in which the mobile device is located.

In accordance with another aspect, the present invention provides a method for providing advertising information to a user. The method includes the steps of supporting a holding device on a shopping cart. The method further includes the step of displaying a recognizable indicia on the holding device. The method includes the step of optically recognizing the recognizable indicia with a mobile device. The method includes the step of transmitting a first set of information related to the optically recognizable image from the mobile device to a server and receiving a second set of information from the server in response.

### BRIEF DESCRIPTION OF THE DRAWINGS

The foregoing and other aspects of the present invention will become apparent to those skilled in the art to which the present invention relates upon reading the following description with reference to the accompanying drawings, in which:

FIG. 1 illustrates a perspective view of an example system for providing advertising information to a user, the system including a holding device being attached to an example shopping cart;

FIG. 2 illustrates a schematic block diagram of an example mobile device;

FIG. 3 illustrates a schematic diagram of an example operation of the system in which the mobile device recognizes a recognizable indicia that is supported by the holding device; and

FIG. 4 illustrates a schematic diagram similar to FIG. 3 in which the mobile device displays advertising information to the user on the mobile device.

### DETAILED DESCRIPTION OF THE INVENTION

Example embodiments that incorporate one or more aspects of the present invention are described and illustrated in the drawings. These illustrated examples are not intended to be a limitation on the present invention. For example, one or more aspects of the present invention can be utilized in other embodiments and even other types of devices. Moreover, certain terminology is used herein for convenience only and is not to be taken as a limitation on the present invention. Still further, in the drawings, the same reference numerals are employed for designating the same elements.

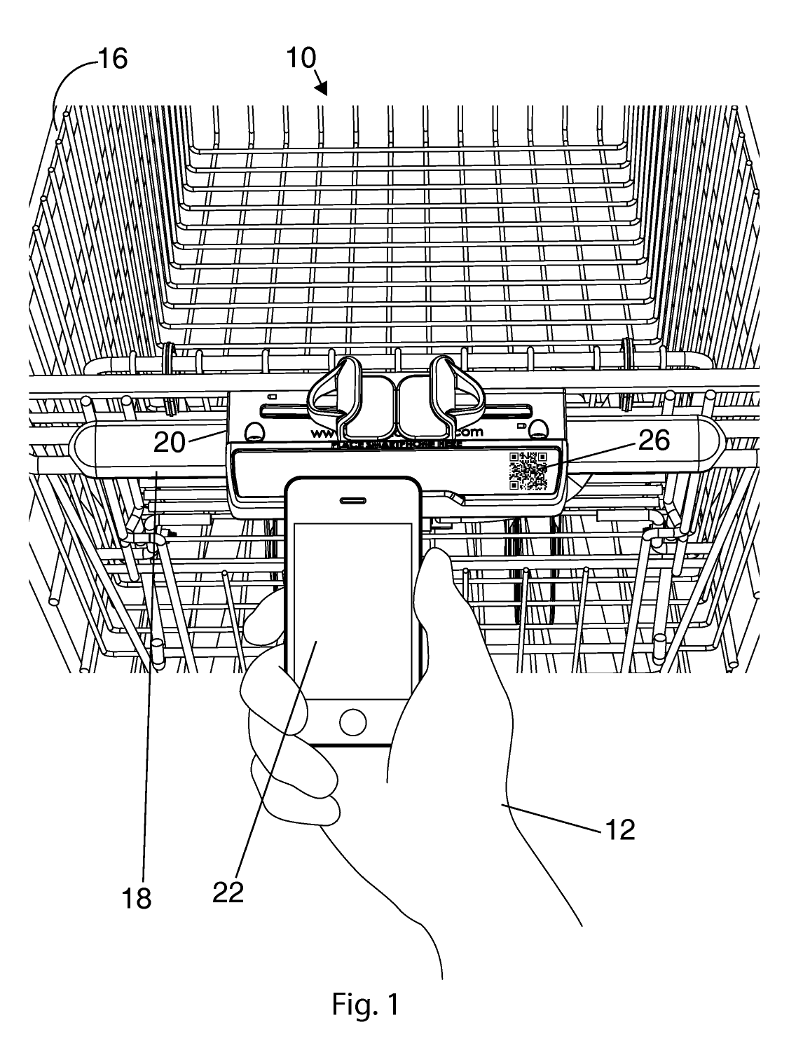

Referring to FIG. 1, a system 10 for providing advertising information to a user 12 is provided. It is to be appreciated that FIG. 1 merely illustrates one example of the possible structure/configuration of the system 10, and that other examples are contemplated. In general, the system 10 can be used in any number of environments, including shopping environments. These shopping environments can include, for example, grocery stores, malls, warehouses, clothing stores, home improvement stores, or the like.

Within one example, a shopping cart 16 can be provided as part of the system 10. The shopping cart 16 is somewhat generically/schematically illustrated as the shopping cart 16 includes any number of sizes, shapes, and constructions. In one example, the shopping cart 16 can include a basket area for receiving items therein. The shopping cart 16 may also include a cart handle 18. The cart handle 18 in this example is a generally linearly extending structure that the user 12 (illustrated as the user's hand) can grip to manipulate and/or move the shopping cart 16. Of course, the cart handle 18 is not limited to the illustrated example, and, instead, could include any number of sizes/shapes, such as by having a larger/smaller cross-sectional size,. extending along a non-linear axis, or the like.

The system 10 can include a holding device 20. The holding device 20 is somewhat generically/schematically depicted in FIG. 1, as the holding device 20 includes any number of constructions, sizes, shapes, etc. In general, the holding device 20 can be supported by a portion of the shopping cart 16, such as the cart handle 18. The holding device 20 can be attached to the cart handle 18, such as with fasteners or the like, or may be one-piece/integrally formed with the cart handle 18. The holding device 20 can removably support a mobile device 22, such that the holding device 20 can selectively hold the mobile device 22.

It is to be appreciated that the mobile device 22 is illustrated in a detached/removed state from the holding device 20 in FIG. 1. Indeed, the user 12 can selectively remove the mobile device 22 so as to hold, grip, and/or manipulate the mobile device 22. In other examples, the user 12 can place the mobile device 22 on the holding device 20, such that the mobile device 22 is supported. As such, the user can walk, shop, move around the store, etc. without having to hold his/her mobile device 22.

The holding device 20 can include a recognizable indicia 26. The recognizable indicia 26 can be positioned at any number of locations on/within the holding device 20. In one example, the recognizable indicia 26 can be located/printed on a placard. This placard can then be removably supported by the holding device 20 (such as by being removably held in a recessed area of the holding device 20). The placard could be selectively removed, such as by an employee of the shopping environment, such that the placard can be changed to display a different recognizable indicia(s) 26. In another example, the holding device 20 is not limited to including the placard, and instead, the recognizable indicia 26 can be stored/located in any number of ways on the holding device 20.

The recognizable indicia 26 can, in one example, include an optically recognizable image. The optically recognizable image can include any number of types of images, including a quick response (“QR”) code, as illustrated. The QR code is an optically readable label that can be printed or attached to the placard or holding device 20. The QR code can be device/machine readable, such that in the illustrated example, the mobile device 22 can recognize and read the QR code. As is generally known, the QR code is a two-dimensional encoded indicia that can transfer data to the user 12 in response to being recognized by the mobile device 22. In an example, the QR code includes squares positioned at corners of the code with black modules/dots arranged in a square grid on a white background. The mobile device 22 can recognize and read the QR code to extract data from the QR code.

While the QR code is one type of optically recognizable image, the recognizable indicia 26 is not so limited. In another example, the recognizable indicia 26 can include nearly any type of barcode, including matrix barcodes, UPC barcodes, or the like.

The recognizable indicia 26 is not limited to including the aforementioned types of optically recognizable images. Instead, the recognizable indicia 26 can include wireless data transmission devices. For instance, in one possible example, the recognizable indicia 26 may include a near field communication chip (e.g., NFC chip/tags, or the like). The NFC chip can be provided/supported within the holding device 20, such as by being supported by the placard. The NFC chip can communicate wirelessly with the mobile device 22 to transmit data/information to the mobile device 22. In an example, the NFC chip can communicate with the mobile device 22 when the mobile device 22 is in proximity to the NFC chip, such as within a meter of the NFC chip.

The recognizable indicia 26 is not limited to NFC, and in other examples, could include radio frequency communication devices (e.g., RFID tags), Bluetooth devices, or the like. Indeed, in these examples, the mobile device 22 can communicate in a similar manner with the recognizable indicia 26 as the aforementioned NFC chip. For example, the mobile device 22 can be moved into proximity with the recognizable indicia 26 (e.g., RFID tag, Bluetooth devices, NFC chip, etc.). With the mobile device 22 in proximity to the recognizable indicia 26, data can be wirelessly transmitted from the recognizable indicia 26 to the mobile device 22.

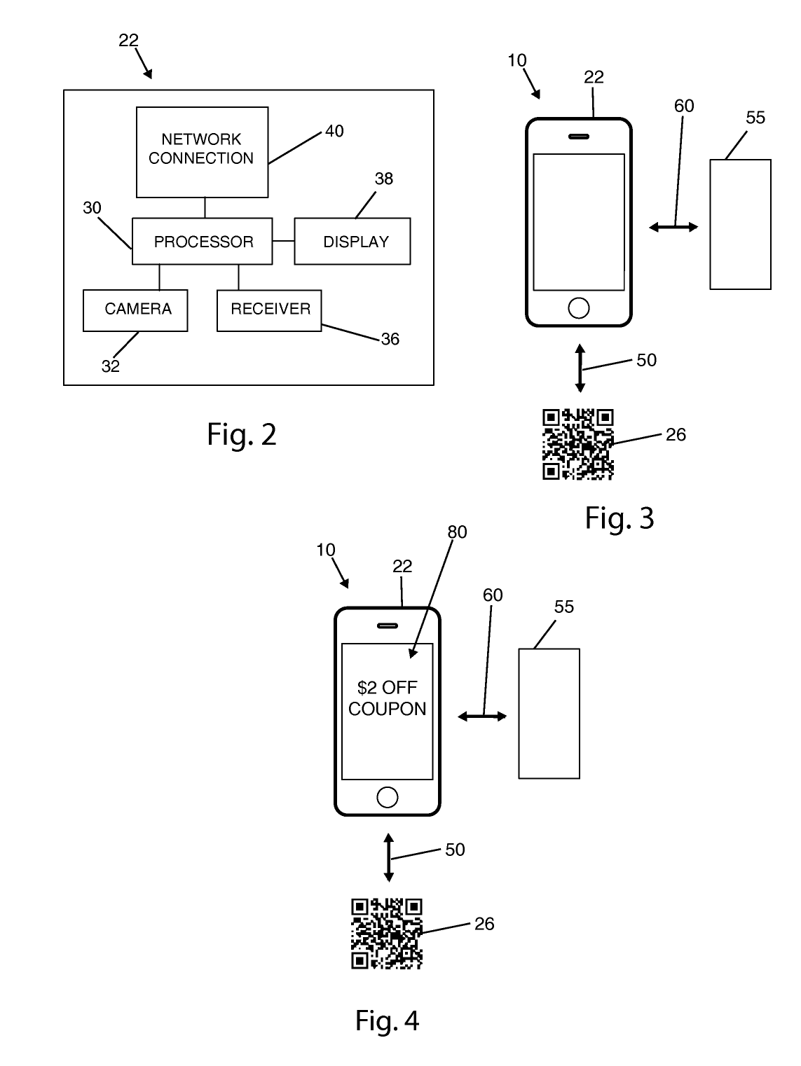

Turning now to FIG. 2, an example of the mobile device 22 is illustrated. The mobile device 22 is shown somewhat generically/schematically in box form so as to illustrate some of the components of the mobile device 22 that may not normally be visible. In operation, however, the mobile device 22 may be closer in appearance to the mobile device 22 illustrated in FIG. 2.

The mobile device 22 can include a processor 30. The processor 30 is generically/schematically depicted in FIG. 2, as the processor 30 includes any number of configurations. In general, the processor 30 is capable of sending/receiving information (e.g., data, control instructions, etc.) to other components within the mobile device 22. The processor 30 can include a controller, microcontroller, printed circuit board, logic units, control units, Memory, etc.

The mobile device 22 can include a camera 32. The camera 32 is generically/schematically depicted in FIG. 2, as the camera 32 includes any number of configurations. In general, the camera 32 can be operatively connected to the processor 30 so as to transmit information to/from the processor 30. The camera 32 can in-take and/or store images and/or video. The camera 32 includes a number of structures, devices, software, etc, associated with the in-taking of images and/or video. For example, the camera 32 can include lenses, sensors, a flash, or the like. In an example, the camera 32 is capable of optically recognizing the recognizable indicia 26 (e.g., QR code, barcode, etc.). For instance, the mobile device 22 can be moved into proximity with the holding device 20, such that the camera 32 is directed/oriented towards the recognizable indicia 26 (e.g., QR code in this example).

The mobile device 22 can also include a receiver 36. The receiver 36 is generically/schematically depicted in FIG. 2, as the receiver 36 includes any number of configurations. The receiver 36 can be operatively connected to the processor 30 so as to transmit information to/from the processor 30. In an example, the receiver 36 includes any number of devices that can communicate with an NFC device, RFID device, Bluetooth device, or the like. In an example, the receiver 36 can recognize the recognizable indicia 26 when the recognizable indicia 26 includes an NFC chip, RFID tag, Bluetooth device, etc. In such an example, the receiver 36 of the mobile device 22 communicates with the recognizable indicia 26 NEC chip, RFID tag, Bluetooth device, etc.) so as to wirelessly receive information from the recognizable indicia 26. It is to be appreciated that the receiver 36 is not merely limited to receiving information from these types of devices, and in at least one example, the receiver 36 can transmit information, such as when interrogating/interacting with the recognizable indicia 26 (e.g., NFC chip, REID tag, Bluetooth device, etc.).

The mobile device 22 can further include a display 38. The display 38 is generically/schematically depicted in FIG. 2, as the display 38 includes any number of configurations. The display 38 includes any number of structures/devices that can show/display information (e.g., text, pictures, images, video, websites, etc.) to the user 12. The display 38 includes, for example, a screen, monitor, or any number of image/video displaying devices. The display 38 can be operatively connected to the processor 30 such that the processor 30 can transmit/receive information to/from the display 38. In an example, the processor 30 can send/transmit information to the display 38 for providing imagery upon the display 38.

The mobile device 22 can further include a network connection 40. The network connection 40 is generically/schematically depicted in FIG. 2, as the network connection 40 includes any number of configurations. In general, the network connection 40 allows for the mobile device 22 to be connected to the internet. In one example, the network connection 40 can communicate (e.g., send/receive information) with a server such that the mobile device 22 can receive information (e.g.. websites, or the like) from the server. The network connection 40 can include, for example, an adapter e.g., wireless adapter), antenna, transmitter/receiver, or the like. The network connection 40 provides for internet access to the mobile device 22 by a local area network (LAN), ethernet, wireless/Wi-Fi, mobile broadband access, etc. The network connection 40 can be operatively connected to the processor 30 such that the network connection 40 can transmit/receive information to/from the processor 30. In an example, at least some of this information (e.g., websites, etc.) can be displayed upon the display 38.

Turning now to FIG. 3, an example of the operation of the system 10 is illustrated. It is to be appreciated that this example operation is somewhat generically/schematically depicted. Indeed, the shopping cart 16, cart handle 18, and holding device 20 are not shown for ease of illustration. In operation, however, the system 10 may appear similar in structure and configuration as the example of FIG. 1.

Initially, the mobile device 22 can be moved into proximity with the recognizable indicia 26 so as to recognize with the recognizable indicia 26. In this example, the recognizable indicia 26 is again illustrated as a QR code. Of course, as set forth above, the recognizable indicia 26 could also include other types of barcodes (e.g., matrix barcodes, UPC barcodes). RFID tags, Bluetooth devices, NFC chips, etc. In an example, the camera 32 of the mobile device 22 can optically recognize the QR code (or barcodes). In other examples, however, the receiver 36 can recognize the recognizable indicia 26 (e.g., RFID tags, Bluetooth devices, NFC chips, etc.). By recognizing the recognizable indicia 26, the mobile device 22 can receive a first set of information 50 from the recognizable indicia 26. In one example, this first set of information 50 can include a website (e.g., URL, etc.) that is associated with the recognizable indicia 26. This website can include a website supported by the owner/proprietor of the shopping area, or, in the alternative, a third party.

Once the mobile device 22 has received this first set of information 50, the mobile device 22 can transmit this first set of information 50 to a server 55. The server 55 is somewhat generically/schematically depicted, as the server 55 includes any number of structures, devices, and configurations. In general, the server includes a system and/or software that can receive and respond to requests to provide a network service. In one example, the mobile device 22 can connect to the server 55 through the network connection 40 of the mobile device 22. The network connection 40 can transmit the first set of information 50 to the server 55. This first set of information 50 can include, for example, a request for a particular website. In response, the server 55 can transmit a second set of information 60 back to the mobile device 22. For example, the second set of information 60 can include the website that was requested by the mobile device 22 with the first set of information 50.

Turning now to FIG. 4, the mobile device 22 can receive this second set of information 60 from the server 55. The mobile device 22 can receive this second set of information 60 through the network connection 40. This second set of information 60 (e.g., a website) can then be transmitted to and displayed upon the display 38.

The second set of information 60 (e.g., a website) can include advertising information 80. The advertising information 80 can hosted/supported by that particular website. The advertising information 80 can include, for example, advertising information related to a store in which the user 12 is currently located and shopping. The advertising information 80 can include nearly any type of information, such as images, text, video, or the like. In at least one example, the advertising information 80 can include coupons (e.g., “$2 OFF COUPON”, etc.), sales, information, events, upcoming deals, new product offerings, or the like. Indeed, the advertising information 80 is not specifically limited to these types of information, and can include nearly any type of information. In one example, the advertising information 80 can be related to gamification. For example, the advertising information 80 could provide rewards in exchange for the user 12 accomplishing certain tasks within the store.

By providing the advertising information 80 to the user 12, the user 12 is provided with a number of benefits. For example, the user 12 may no longer need to search for printed coupons, advertisements, offerings, discounts, or the like. Indeed, the user 12 need riot subscribe by mail to these types of advertising information. Rather, the system 10 can allow for the user 12 to receive advertising information 80 that is targeted towards store coupons/offers to the user 12. The advertising information 80 can further include upcoming events or specials, thus making it more likely for the user 12 to revisit the store at a later date. Further still, the advertising information 80 can be related to gamification, such as by offering rewards, thus making the shopping experience for the user 12 more enjoyable. Since the advertising information 80 is hosted on a website, the advertising information 80 can be easily and periodically changed/updated, to match current sales, specials, coupons, etc.

The invention has been described with reference to the example embodiments described above. Modifications and alterations will occur to others upon a reading and understanding of this specification. Example embodiments incorporating one or more aspects of the invention are intended to include all such modifications and alterations insofar as they come within the scope of the appended claims.

What is claimed is:

1. A system for providing advertising information to a user, the system including:
a holding device attached to a shopping cart, the holding device being configured to removably hold a mobile device: and
a recognizable indicia supported by the holding device, the recognizable indicia being recognizable by the mobile device such that the mobile device is configured to transmit a first set of information related to the recognizable indicia to a server and receive a second set of information from the server in response.

2. The system of claim 1, wherein the recognizable indicia includes an optically recognizable image.

3. The system of claim 2, wherein the optically recognizable image includes a quick response (QR) code.

4. The system of claim 1, wherein the recognizable indicia includes a near field communication chip.

5. The system of claim 1, wherein the recognizable indicia includes a radio frequency communication device.

6. The system of claim 1, wherein the second set of information includes an advertisement.

7. The system of claim 6, wherein the advertisement is configured to be displayed on a display of the mobile device.

8. A system for providing advertising information to a user, the system including:
a holding device attached to a shopping cart, the holding device being configured to removably hold a mobile device; and
a recognizable indicia supported by the holding device, the recognizable indicia being recognizable by the mobile device such that the mobile device is configured to transmit a first set of information related to the recognizable indicia to a server and receive a second set of information from the server in response, wherein the second set of information received by the mobile device includes an advertisement related to a store in which the mobile device is located.

9. The system of claim 8, wherein the recognizable indicia includes an optically recognizable image.

10. The system of claim 9, wherein the optically recognizable image includes a quick response (QR) code.

11. The system of claim 8, wherein the recognizable indicia includes a near field communication chip.

12. The system of claim 8, wherein the recognizable indicia includes a radio frequency communication device.

13. A method for providing advertising information to a user, the method including the steps of:
supporting a holding device on a shopping cart;
displaying a recognizable indicia on the holding device;
optically recognizing the recognizable indicia with a mobile device; and
transmitting a first set of information related to the optically recognizable indicia from the mobile device to a server and receiving a second set of information from the server in response.

14. The method of claim 13, wherein the recognizable indicia includes an optically recognizable image.

15. The method of claim 14, wherein the optically recognizable image includes a quick response (QR) code.

16. The method of claim 13, wherein the recognizable indicia includes a near field communication chip.

17. The method of claim 13, wherein the recognizable indicia includes a radio frequency communication device.
